(19) United States
(12) Patent Application Publication
(10) Pub. No.: US 2026/0162191 A1
(43) Pub. Date: Jun. 11, 2026

(54) Application of Geographical Spatial Data For Determining Applicable Tax Rules and Codes

(71) Applicant: Oracle International Corporation, Redwood Shores, CA (US)

(72) Inventors: Allen Roshan D’Souza, Houston, TX (US); Dipen Ashvinkumar Joshi, Katy, TX (US); Ankur Handa, Santa Clara, CA (US); Mukesh Tyagi, Aldie, VA (US); Shovan Sutar, Palo Alto, CA (US); Srikanth Reddy Surapu, Bridgewater, NJ (US); Konatham Chandrajith Yadav, Hyderabad (IN); Shashi Kanth Gottipati, Hyderabad (IN); Venkata Narsimha Rao Gurrapu Srinivas, Hyderabad (IN)

(73) Assignee: Oracle International Corporation, Redwood Shores, CA (US)

(21) Appl. No.: 19/279,476

(22) Filed: Jul. 24, 2025

Related U.S. Application Data
(60) Provisional application No. 63/730,142, filed on Dec. 10, 2024.

(51) Int. Cl. G06Q 40/12; G06T 11/20

(52) U.S. Cl. CPC G06Q 40/123; G06T 11/26

(57) ABSTRACT

Techniques for determine tax information for an entity based in part on plotting an entity address into one of a set of polygons respectively associated with taxing jurisdictions are disclosed. Initially, the system partitions a geographical region into a plurality of polygons based on geospatial files. The polygons correspond to taxing jurisdictions. The system determines geographical coordinates for an address, e.g. residence of an entity, employee, and the geographical coordinates are used to plot the first address within the geographical region. The system identifies the polygons that include the address and determines the tax jurisdictions corresponding to the polygons. Based on the tax jurisdictions and tax attributes of the entity, the system calculates a set of tax information for the entity that are presented to a user for viewing.

### BENEFIT CLAIMS; RELATED APPLICATIONS; INCORPORATION BY REFERENCE

This application claims the benefit of U.S. Provisional Patent Application 63/730,142, filed Dec. 10, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to determining tax implications for an entity. In particular, the present disclosure relates to the use of spatial data for determining applicable tax rules and codes.

### BACKGROUND

Tax rules vary by geography, governed by national, regional, and local authorities. National taxes include income tax, corporate tax, VAT/GST, excise taxes, and customs duties. Rates and structures differ by country. State/Provincial taxes include state income tax, sales tax, and property tax, with variations within countries, e.g., U.S., Canadian provinces. Local taxes include city-level taxes, like property tax, local sales tax, or specific assessments for infrastructure and services. In addition, where an individual resides and/or works may affect the tax implications for the individual.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a tax management tool system in accordance with one or more embodiments;

FIG. 2 illustrates an example set of operations for determining tax information for an entity based on plotting of an entity address in accordance with one or more embodiments;

FIGS. 3A-3E illustrate an example embodiment accordance with one or more

FIG. 4 illustrates a machine learning (ML) engine in accordance with one or more embodiments;

FIG. 5 illustrates an example set of operations of the ML engine of FIG. 5; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. TAX MANAGEMENT TOOL SYSTEM ARCHITECTURE
3. DETERMINING TAX INFORMATION FOR AN ENTITY BASED ON PLOTTING OF AN ENTITY ADDRESS
4. EXAMPLE EMBODIMENT
5. PRACTICAL APPLICATIONS, ADVANTAGES & IMPROVEMENTS
6. MACHINE LEARNING ENGINE ARCHITECTURE
7. GENERATIVE MODELS
8. MACHINE LEARNING ENGINE OPERATION
9. HARDWARE OVERVIEW
10. MISCELLANEOUS; EXTENSIONS

### 1. General Overview

One or more embodiments determine tax information for an entity based in part on plotting an entity address into one of a set of polygons respectively associated with taxing jurisdictions. Initially, the system partitions a geographical region into a plurality of polygons, based on geospatial files. The polygons correspond to taxing jurisdictions. The system determines geographical coordinates for an address, e.g. residence of an entity, employee, and the geographical coordinates are used to plot the first address within the geographical region. The system (a) identifies the polygons that include the address and (b) determines the tax jurisdictions corresponding to the polygons. Based on the tax jurisdictions and tax attributes of the entity, the system calculates a set of tax information for the entity that are presented to a user for viewing.

One or more embodiments determine multiple sets of tax information for the entity based on different addresses and/or tax attributes for the entity and/or different time periods. The system may present the multiple sets of tax information to the user for comparison, i.e., side-by-side view.

One or more embodiments apply a trained ML model to the tax information to identify recommendations to the entity responsive to the tax information. The recommendations may include compliance actions, optimization strategies, and/or risk mitigation. The system may present the tax information and/or recommendations to the user in a dashboard or report. The dashboard or report may include interface elements for initiating the recommendations responsive to selection by a user.

One or more embodiments described in this Specification and/or recited in the claims may not be included in this General Overview section.

### 2. Tax Management Tool System Architecture

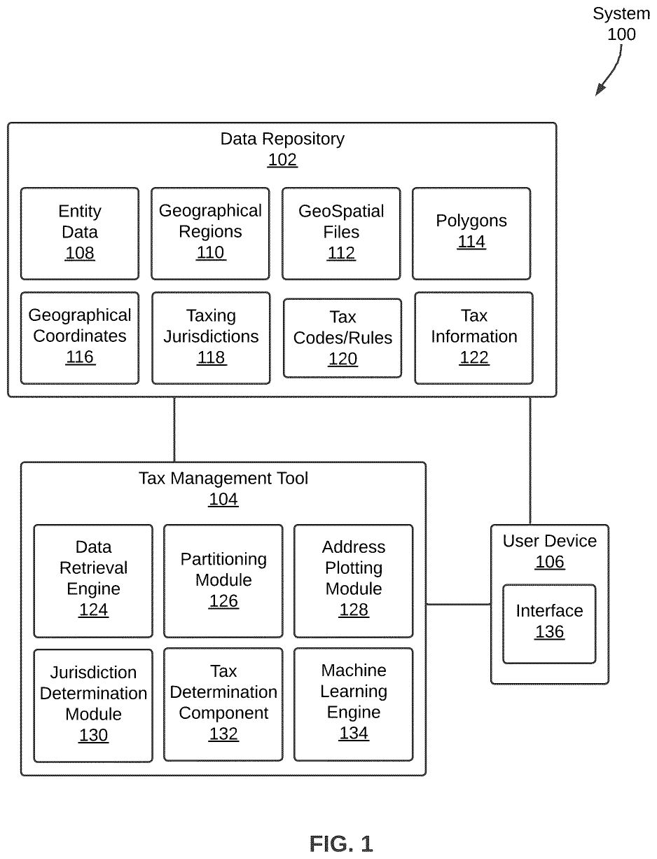

FIG. 1 illustrates a tax management tool system 100 in accordance with one or more embodiments. As illustrated in FIG. 1, system 100 includes a data repository 102, a tax management tool 104, and a user device 106. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In one or more embodiments, data repository 102 is any type of storage unit and/or device (e.g., a file system, database, collection of tables, or any other storage mechanism) for storing data. Furthermore, data repository 102 may include multiple different storage units and/or devices. The multiple different storage units and/or devices may or may not be of the same type or located at the same physical site. Furthermore, data repository 102 may be implemented or executed on the same computing system as tax management tool 104. Additionally, or alternatively, data repository 102 may be implemented or executed on a computing system separate from tax management tool 104. Data repository 102 may be communicatively coupled to tax management tool 104 via a direct connection or via a network.

Information describing operations for determining tax information for an entity based in part on plotting an entity address into one of a set of polygons respectively associated with taxing jurisdictions may be implemented across any of components within the system 100. However, this information is illustrated within data repository 102 for purposes of clarity and explanation.

In one or more embodiments, data repository 102 includes entity data 108, geographical regions 110, geospatial files 112, polygons 114, geographical coordinates 116, taxing jurisdictions 118, tax codes/rules 120, and/or tax information 122.

In one or more embodiments, entity data 108 refers to a structured set of data attributes associated with a subject entity, e.g., an individual, business, or organization. The system uses entity data 108 to identify applicable tax rules and liabilities. Entity data 108 may include one or more addresses that correspond to a location associated with the entity, e.g., a principal place of residence or business. Entity data 108 may include legal classification, operational characteristics, and other tax-relevant attributes. Entity data 108 may include a name or identifier of the entity and an entity type, e.g., individual, corporation, nonprofit organization. Entity data 108 may include financial, legal, or operational characteristics, e.g., industry classification, revenue range, employee count, or filing status. Entity data may persist in association with a unique entity identifier and may be updated dynamically in response to changes in address, operational structure, or tax regulations. The data structure representing the entity data may be implemented as a relational database record, a structured document (e.g., JSON or XML), or an object in an object-oriented data model.

In one or more embodiments, geographical regions 110 refer to spatially bounded areas defined by geographic coordinates. The system may represent geographic regions 110 as digital geometric constructs, such as polygons, which are stored in association with jurisdictional identifiers. Each geographical region corresponds to a taxing jurisdiction or sub-jurisdiction (e.g., federal, state, county, city, special district) and is used by a tax determination system to resolve location-specific tax obligations.

In one or more embodiments, geographical regions 110 are defined in a geospatial data structure. The boundaries of the region may be encoded using one or more coordinate-based geometries, typically polygonal shapes expressed as a series of ordered latitude and longitude pairs or projected coordinate system values. The region geometries may be stored in a geospatial file format, such as ESRI Shapefile, GeoJSON, or a spatially indexed database supporting formats such as Well-Known Text (WKT) or Well-Known Binary (WKB).

In one or more embodiments, geographical regions 110 may be associated with one or more tax attributes. Tax attributes may include a unique region identifier, jurisdiction type (e.g., municipality, school district, tax collection district), applicable tax codes or classifications (e.g., Political Subdivision (PSD) code, Zone Improvement Plan (ZIP)+4 override), tax rates (e.g., earned income tax rate, sales tax rate, property tax millage), temporal validity (e.g., effective date ranges for changes in boundaries or rates), and/or legal authority or regulatory source.

In one or more embodiments, geospatial files 112 refer to digital data structures comprising geographic boundary representations encoded in a machine-readable format. Each boundary may define a spatial extent of a corresponding jurisdiction, region, or area of regulatory applicability. Each geospatial file may include, or be associated with, one or more geometric primitives (e.g., points, polylines, polygons) that define the shape and location of the spatial region within a specified coordinate reference system (CRS).

In one or more embodiments, geospatial files 112 encode one or more polygonal geometries, where each polygon corresponds to a physical or legal region, such as a municipality, county, tax district, school district, zoning region, or regulatory area. Each polygon may include a sequence of coordinate pairs (latitude and longitude or projected coordinates) that define a closed loop representing the boundary of the region. The polygons may optionally include internal holes or multipart geometries to represent complex or discontinuous regions.

In one or more embodiments, geospatial files 112 are structured in accordance with standard geospatial data format, such as ESRI Shapefile, GeoJSON, KML, GML, or WKT. Geospatial files 112 may include or reference metadata attributes associated with each geometric feature. The metadata may include unique identifiers, region names, classification codes, effective dates, legal authority references, or jurisdiction-specific rules (e.g., tax rates or enforcement thresholds).

In one or more embodiments, geospatial files 112 are stored in a persistent storage medium or served from a geospatial data service or API. The file may be indexed using spatial indexing techniques (e.g., R-trees, quadtrees) to enable efficient spatial queries. Additionally, the geospatial file may support temporal attributes to enable versioning or historical analysis of boundaries (e.g., changes in jurisdictional boundaries over time).

In one or more embodiments, polygons 114 refer geometric data structures that represent two-dimensional, closed shapes defined by sequential sets of coordinates (e.g., latitude and longitude pairs) forming a boundary around spatial areas. Polygons 114 may correspond to a tax jurisdiction or sub-jurisdiction, such as a municipality, school district, county, tax collection district, or special taxing authority. Polygons 114 may be encoded using a geospatial format (e.g., GeoJSON, Shapefile, KML, WKT, or WKB) and may be defined by a linear ring of vertices, where the first and last coordinates are identical to ensure geometric closure. Polygons 114 may include one or more interior rings (holes) to represent exclusions or voids within the jurisdictional boundary. Multiple polygons may be grouped into a multipolygon to represent non-contiguous areas governed by a single tax authority.

In one or more embodiments, polygons 114 are associated with metadata. Metadata may include a unique jurisdictional identifier (e.g., PSD code, region ID), polygon type (e.g., city boundary, tax district, service area), applicable tax rates (e.g., earned income tax, sales tax, property tax), legal authority or reference to enabling statutes, and/or effective and expiration dates for time-bounded jurisdictional applicability.

In one or more embodiments, geographical coordinates 116 refer to a pair of numerical values representing a specific location on the Earth's surface. Geographical coordinates 116 may be expressed as a latitude and longitude pair within a defined CRS such as WGS 84. Geographical coordinates 116 serve as the spatial input for resolving the jurisdictional applicability of tax rules based on the physical location of an entity, property, or transaction.

In one or more embodiments, taxing jurisdictions 118 refer to geographically and legally defined authorities with the power to impose, administer, and collect taxes. Taxing jurisdictions 118 represent discrete spatial or administrative units, such as cities, counties, states, or special districts, each associated with one or more applicable tax rules, rates, exemptions, or filing requirements.

In one or more embodiments, taxing jurisdictions 118 are represented as data objects that include a unique jurisdiction identifier (e.g., PSD code, Federal Information Processing Standards (FIPS) code, jurisdiction key), a jurisdiction type (e.g., municipal, county, state, school district, special district), one or more associated tax rules (e.g., earned income tax, sales tax, property tax), one or more geographical boundaries defined by polygonal geometries, a temporal scope (e.g., effective and expiration dates of jurisdictional validity), and/or optional metadata (e.g., governing authority name, jurisdiction contact information, legal basis).

In one or more embodiments, taxing jurisdictions 118 are organized hierarchically (e.g., a city within a county within a state) or exist in parallel (e.g., a school district overlapping a municipal boundary). Taxing jurisdiction data may be versioned to support historical or future-effective tax determinations. The jurisdictional boundaries may be stored in a spatial database or geospatial file format (e.g., Shapefile, GeoJSON, WKT) and indexed using spatial indexing structures to enable high-performance lookup and containment operations.

In one or more embodiments, tax codes/rules 120 refer to structured, machine-readable representations of regulatory provisions that define how taxes are to be calculated, withheld, reported, or exempted within one or more taxing jurisdictions 118. Tax codes/rules 120 rules may govern the application of specific tax types (e.g., income tax, sales tax, property tax) and are used by a tax determination system to compute tax liabilities or obligations based on the attributes of a subject entity and its associated location or activity.

In one or more embodiments, each tax rule or tax code entry is associated with one or more attributes. Attributes may include the following: a jurisdiction identifier (e.g., PSD code, FIPS code, municipal ID) that links the rule to a specific taxing authority or geographic region; a tax type (e.g., earned income tax, local services tax, value-added tax, business privilege tax); a rule identifier or code (e.g., standardized or proprietary code used to reference the rule); a rule expression or computation logic that defines how the tax is calculated (e.g., flat rate, tiered bracket, percentage of gross receipts); applicability conditions, such as thresholds, exemptions, or entity types to which the rule applies; effective dates and expiration dates for rule enforcement; filing or remittance requirements, such as due dates, form types, or reporting intervals; and/or legal references or regulatory citations supporting the rule.

In one or more embodiments, tax information 122 refers to a set of structured, computed, or retrieved data elements that describe an entity's tax-related obligations or entitlements within one or more taxing jurisdictions. Tax information 122 may include tax liabilities, withholding amounts, exemption statuses, tax credits, filing requirements, and remittance instructions. A tax liability is a quantifiable monetary obligation owed by an entity to a taxing authority, determined by evaluating a set of tax rules or codes in the context of the entity's attributes and its associated jurisdiction. Tax liabilities are computed using jurisdiction-specific formulas, rates, and thresholds, and may vary based on the type of tax (e.g., income tax, sales tax, property tax), the legal structure of the entity, and its reported or inferred economic activity (e.g., income, gross receipts, asset holdings).

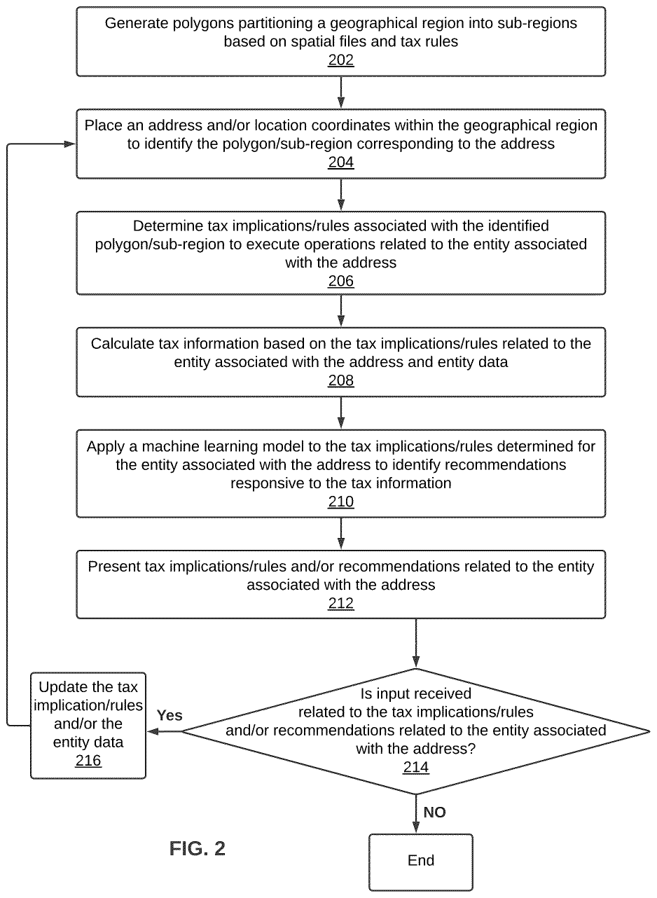

In one or more embodiments, tax management tool 104 refers to hardware and/or software configured to perform operations described herein for determining tax information for an entity based in part on plotting of an entity address. Examples of operations for determining tax information for an entity based in part on plotting an entity address are described below with reference to FIG. 2.

In an embodiment, tax management tool 104 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, data retrieval engine 124 refers to hardware and/or software configured to perform operations described herein for selectively accessing, querying, and retrieving structured and/or unstructured data required for determining tax information. Data retrieval engine 124 serves as the interface between input entities (e.g., taxpayers, businesses, addresses) and one or more data repositories including jurisdictional, regulatory, geographic, and financial data necessary for evaluating tax rules and producing tax information such as liabilities, rates, and exemptions.

In one or more embodiments, data retrieval engine 124 operates over a combination of local and remote data sources, including geospatial databases storing polygonal boundary data for taxing jurisdictions; regulatory repositories containing tax rules and codes indexed by jurisdiction and effective date; entity master records including attributes, such as legal classification, income, address, residency, and industry classification; lookup tables mapping jurisdictional identifiers (e.g., PSD codes, FIPS codes) to applicable tax parameters; and/or historical records supporting retroactive tax evaluation or audit traceability.

In one or more embodiments, partitioning module 126 refers to hardware and/or software configured to perform operations described herein that subdivide a geographic region into discrete, non-overlapping spatial units, each corresponding to a unique taxing jurisdiction or combination of jurisdictions. Partitioning module 126 may facilitate efficient spatial resolution of tax rules, rates, and liabilities based on the physical or operational location of an entity.

In one or more embodiments, partitioning module 126 utilizes geometric operations, such as polygon union, intersection, and difference, and leverages computational geometry libraries or geospatial databases with support for topological integrity and spatial indexing. The output of the partitioning module is stored as a new set of spatial features (e.g., in a Shapefile, GeoJSON, or PostGIS table) with each feature tagged with jurisdictional identifiers (e.g., PSD codes, FIPS codes), tax attributes (e.g., composite tax rates, exemption flags), rule references applicable to that region, and/or effective and expiration timestamps for versioned analysis.

In one or more embodiments, address plotting module 128 refers to hardware and/or software configured to perform operations described herein for processing address data and compute precise geographic coordinates that are used to determine the applicable tax jurisdictions and corresponding tax rules for an entity or transaction. Address plotting module 128 may spatially resolve input addresses into a format suitable for geospatial evaluation. Address plotting module 128 supports rooftop-level, parcel-level, or interpolated point resolution, depending on available data and accuracy requirements. Address plotting module 128 ensures that address inputs—whether from individuals, businesses, or third-party systems—are translated into precise, jurisdictionally aligned geographic coordinates. This enables accurate determination of the following: tax authorities that govern an address; tax rules and rates that apply; and/or the entity is subject to overlapping or exclusive jurisdictional taxation. By enabling precise spatial alignment between address data and geographic tax boundaries, address plotting module 128 ensures compliance, reduces ambiguity in multi-jurisdictional settings, and supports automated, location-aware tax decisioning at scale.

In one or more embodiments, jurisdiction determination module 130 refers to hardware and/or software configured to perform operations described herein for identifying one or more taxing jurisdictions applicable to a specific entity, location, or transaction, based on geospatial and contextual inputs. Jurisdiction determination module 130 enables automated resolution of jurisdiction-specific tax rules, obligations, and compliance requirements.

In one or more embodiments, tax determination component 132 refers to hardware and/or software configured to perform operations described herein for computing, inferring, and/or validating tax obligations, liabilities, or entitlements applicable to an entity or transaction. Tax determination component 132 operates by applying jurisdiction-specific tax rules to a set of input data that includes geographic, financial, and/or contextual attributes of the entity or event. Tax determination component 132 enables accurate, rules-driven evaluation of tax responsibilities across multiple regulatory environments.

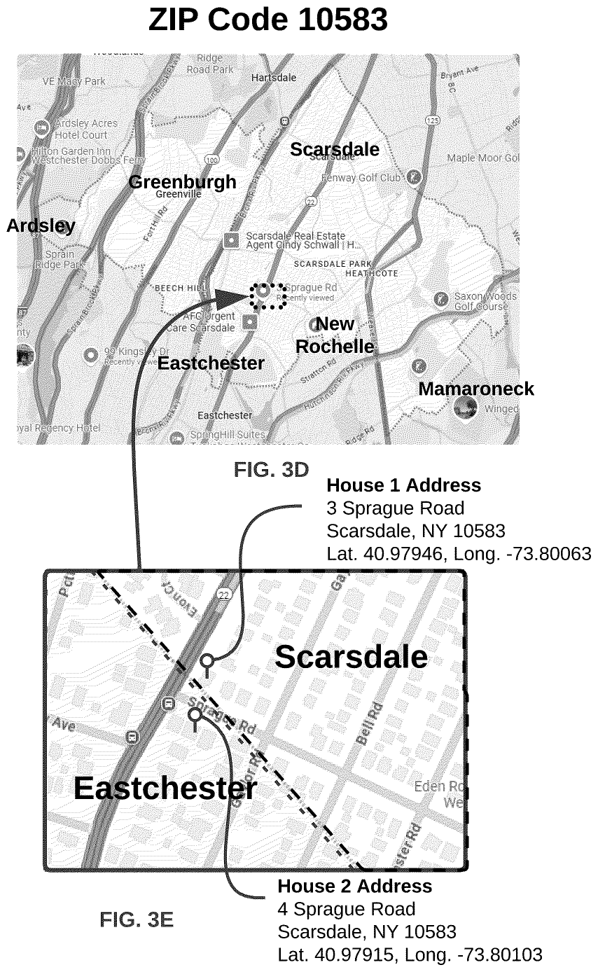

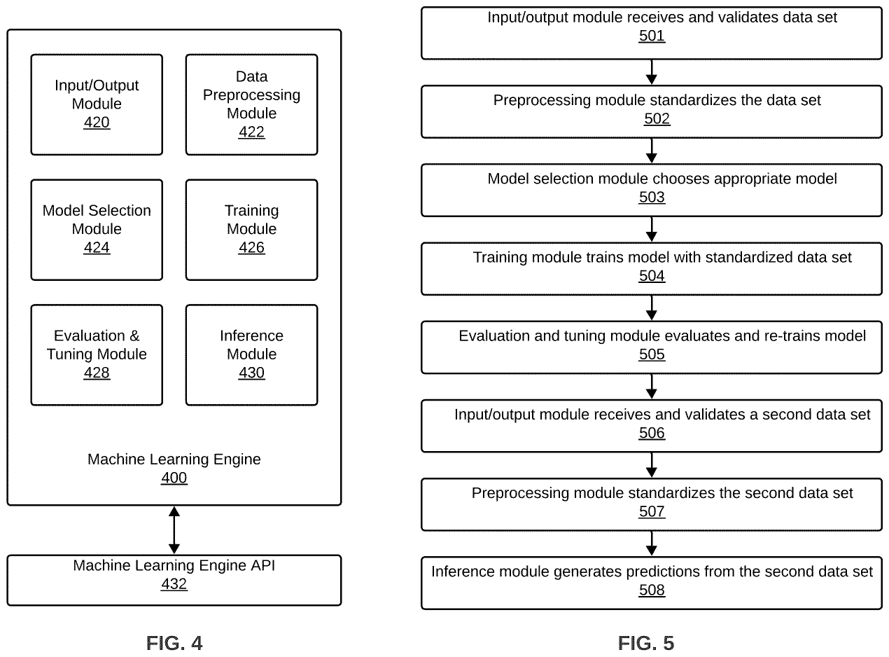

In one or more embodiments, ML model 134 refers to hardware and/or software configured to perform the operations described herein for training and applying machine learning models. The structure and function of ML engine 134 will be described below in detail with respect to ML engine 400 and FIGS. 4 and 5.

In one or more embodiments, user device 106 includes an interface 136. Interface 136 refers to hardware and/or software configured to facilitate communications between a user and tax management tool 104. Interface 136 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 136 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 136 is specified in one or more other languages, such as Java, C, or C++.

### 3. Determining Tax Information for an Entity Based on Plotting of an Entity Address

FIG. 2 illustrates an example set of operations for determining tax information for an entity based on plotting of an entity address in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

One or more embodiments generate polygons partitioning a geographical region into sub-regions based on spatial files and tax rules (Operation 202). Initially, the system ingests geospatial files containing jurisdictional boundary definitions, such as those representing cities, counties, school districts, or special tax districts. The geospatial files, typically formatted in standards, like Shapefile, GeoJSON, or GML, are parsed and normalized by converting the geometries into a common CRS. During normalization, the system may validate geometries to correct topological errors, such as self-intersections or gaps, and/or to simplify the geometries for computational efficiency. The system may also perform boundary alignment to ensure that shared edges across jurisdictions snap cleanly, eliminating small slivers or overlaps.

In one or more embodiments, once the source geometries are validated, the system may compute all spatial intersections across jurisdictional layers to identify overlapping regions. Each unique intersection, such as the overlap of a city and a school district, defines a composite sub-region where a specific combination of tax rules apply. The system continues by resolving the full partition of the original geographic region into mutually exclusive, contiguous polygons that together cover the entire area without gaps or overlaps. Default zones may be introduced to cover locations not falling within any specified tax jurisdiction.

In one or more embodiments, the system associates tax rule metadata with each generated polygon. This involves querying a jurisdiction-linked tax rule repository and aggregating tax attributes relevant to the jurisdictions comprising each sub-region. The system may tag the resulting polygon with information, such as jurisdiction identifiers (e.g., PSD or FIPS codes), applicable tax rates (e.g., earned income tax, local services tax), rule identifiers, and effective date ranges. These enriched polygons are then persisted to a spatial database or geospatial data store, such as PostGIS, with spatial indexing (e.g., R-tree structures) to support rapid point-in-polygon queries.

In one or more embodiments, the system maintains versioned polygon datasets to reflect historical or anticipated jurisdiction boundary changes, allowing for temporally accurate tax evaluations. The final set of partitioned polygons may be visualized through GIS tools or exported to interoperable formats for integration with downstream applications. This end-to-end process results in a fine-grained spatial representation of tax rule applicability, enabling accurate and scalable tax determination based on precise location data.

One or more embodiments place an address and/or location coordinates within the geographical region to identify the polygon/sub-region corresponding to the address (Operation 204). Initially, the system receives an input location that may be provided as a textual address (e.g., street, city, ZIP code). The system may invoke a geocoding operation to convert the address into a set of geographic coordinates using an internal geocoding engine or third-party service. This step ensures that all location data is represented consistently as point coordinates in a common CRS.

Once the coordinates are determined, the system performs a point-in-polygon spatial query to locate the corresponding polygon from a set of precomputed, non-overlapping tax jurisdiction polygons. These polygons represent sub-regions that partition a larger geographical area and are each associated with a specific set of tax rules or jurisdictions. The system may use spatial indexing structures, such as R-trees or quad-trees, to accelerate the containment operation and return the enclosing polygon(s) with minimal computational overhead.

In one or more embodiments, when multiple jurisdiction layers are maintained, such as city, school district, and county boundaries, the system evaluates the point against each layer independently and aggregate the results into a composite jurisdictional profile for the location. Each matched polygon is returned along with metadata identifying the jurisdiction (e.g., PSD code, jurisdiction name), the applicable tax rule set, and any constraints or qualifiers associated with the tax obligations for that sub-region. The result of this operation is a precise, spatially grounded determination of which tax jurisdiction or combination of jurisdictions govern the input location.

One or more embodiments determine tax implications/rules associated with the identified polygon/sub-region to execute operations related to the entity associated with the address (Operation 206). Once a polygon or sub-region has been identified for a given address or location, the system proceeds to determine the tax implications or applicable rules associated with that polygon. Each polygon is associated with one or more jurisdiction identifiers (e.g., municipal, school district, county, or special tax district) that serve as keys for retrieving tax rule metadata from a centralized tax rules repository. The system may query this repository to extract all tax rules relevant to the identified jurisdictions, filtering by rule type (e.g., income tax, gross receipts tax, local services tax), effective date range, and any entity-specific applicability constraints, such as entity classification, residency status, or revenue thresholds.

In one or more embodiments, once the relevant rules are retrieved, the system evaluates them in the context of the entity's attributes, such as its legal structure (e.g., sole proprietorship, corporation), filing status, income, exemptions, or other tax-relevant data. This evaluation may include computing applicable tax rates, determining thresholds for liability, assessing eligibility for deductions or credits, and identifying filing or remittance obligations. The rules may also define conditions under which certain tax forms are required, when tax payments are due, or if withholding is mandated for the entity based on its location within the polygon.

In one or more embodiments, the tax implications are codified as structured outputs (e.g., tax rate tables, filing instructions, or computed liabilities), which can be used to execute additional operations. Additional operations may include generating tax returns, updating payroll withholding settings, triggering compliance alerts, or initiating remittance workflows. The system may support real-time or batch processing and logs each determination, along with the associated rules and jurisdictions, for auditability. This rules-driven operation ensures that the tax treatment of the entity is consistent with current jurisdictional requirements derived directly from its geographic placement within a defined sub-region.

One or more embodiments calculate tax information based on the tax implications/rules related to the entity associated with the address and entity data (Operation 208). The system may calculate tax information by applying the tax implications and rules associated with the identified polygon or jurisdictional sub-region to the specific attributes of the entity linked to the address. This process may begin with the assembly of a structured dataset that includes both the applicable tax rules, retrieved based on the entity's geographical placement, and the entity-specific data necessary to perform tax computations. Entity data may include legal classification, income or revenue amounts, number of employees, residency status, exemption claims, and/or prior filing history.

In one or more embodiments, the system executes a tax determination component that interprets each applicable tax rule in the context of the entity's attributes. For example, the system may calculate a local earned income tax by applying a percentage rate defined by the jurisdiction to the entity's reported wages while simultaneously checking for income thresholds that exempt certain classes of workers or residents. Other rules may define flat fees (e.g., local services tax), minimum thresholds for gross receipts taxes, or caps on liability. In cases where multiple jurisdictions overlap, the system may calculate tax information for each applicable jurisdiction independently and then may aggregate or reconcile the results based on precedence logic or statutory stacking rules.

In one or more embodiments, the output of the calculation process includes detailed tax information, such as total liability amounts, applicable rates, exemptions applied, due dates, withholding requirements, and any corresponding jurisdictional identifiers. This tax information may be structured for use in downstream systems, for example, generating remittance instructions, updating payroll systems, pre-populating filing forms, or producing audit-ready reports. The system may also flag incomplete inputs, ambiguous conditions, or rule conflicts for manual review. The tax determination component may be modular, allowing for re-evaluation in response to updates in tax rules, jurisdictional boundaries, or entity data, thus ensuring continuous compliance and adaptability to changing tax regulations.

One or more embodiments apply an ML model to the tax implications/rules determined for the entity associated with the address to identify recommendations responsive to the tax information (Operation 210). Once the tax implications and rules have been determined for an entity based on its associated address and jurisdictional placement, the system may apply one or more ML models to the tax implications and/or rules to analyze the tax attributes in conjunction with the entity's data. The ML models may generate personalized recommendations. The ML models may be trained on historical tax filings, compliance outcomes, prior taxpayer behavior, financial performance, and/or jurisdiction-specific enforcement trends. The ML models may be trained to identify patterns and optimal responses to complex or overlapping tax obligations.

In one or more embodiments, the ML model receives as input a feature set that includes the entity's calculated tax information (e.g., liabilities, applicable tax types, exemption statuses), contextual data (e.g., industry, entity size, geographic location), and the specific tax rules identified from the jurisdictional sub-region. The ML model may evaluate this data to infer if there may be opportunities for tax savings, filing optimizations, overpayment avoidance, eligibility for credits or deductions, or potential compliance risks. For example, the ML model might recommend an alternative address to reduce exposure to local payroll taxes, suggest filing as a different legal entity type to take advantage of preferential rates, or identify filing anomalies based on peer benchmarks within similar jurisdictions.

In one or more embodiments, the output of the ML model is a set of structured recommendations, ranked by relevance or potential financial impact, and optionally accompanied by explanatory notes or confidence scores. The recommendations may include various actions, such as amending prior returns, adjusting withholdings, electing alternative filing positions, or seeking professional review. The ML model incorporates feedback mechanisms to improve accuracy over time, learning from user interactions, confirmed actions, and audit results. This intelligent recommendation process transforms static rule evaluation into adaptive, data-driven guidance tailored to the specific tax circumstances of the entity.

One or more embodiments present tax implications/rules and/or recommendations related to the entity associated with the address (Operation 212). The system may proceed to present the tax implications/rules and/or recommendations through a structured, user-facing interface or API response. The interface may convey relevant tax details, such as applicable jurisdiction(s), tax types (e.g., earned income tax, gross receipts tax), computed liabilities, rule references, and any identified exemptions or credits. The system may format this information into a human-readable form, such as tables, charts, or summarized narratives. The system may maintain links to the underlying data structures for programmatic use or further review.

In one or more embodiments, the recommendations provided by the ML models are grouped and displayed alongside the computed tax information. The system may provide the recommendations with associated rationales, confidence scores, or estimated impact values to help the user understand the significance of each suggestion. The system may categorize the recommendations, for instance, into cost-saving opportunities, compliance alerts, or filing optimizations. If applicable, the system may highlight time-sensitive actions, such as upcoming due dates or thresholds that affect eligibility.

In one or more embodiments, the system delivers the tax information via multiple modalities, including a web interface, embedded widget in a tax software platform, or API response for downstream consumption. To enhance transparency, the system may also expose jurisdictional metadata, such as governing authority names, PSD or FIPS codes, or legal citations backing each rule. Interactive capabilities may allow users to drill down into specific rules or simulate alternative inputs to evaluate how changes (e.g., different addresses) would affect their tax outcome. The goal of this operation is to enable human or system users, to interpret, validate, and act on complex tax determinations with clarity, accuracy, and contextual relevance.

In one or more embodiments, the system includes functionality for displaying comparisons of tax implications across different addresses and/or entity attributes to support decision-making, planning, and optimization. This comparison operation involves selecting two or more address-entity combinations and generating side-by-side or tabular representations of the tax consequences associated with each. For each location, the system performs jurisdiction determination, tax rule retrieval, and tax calculation operations as previously described, accounting for both geographic placement (e.g., differences in local income tax, services tax, or business privilege tax) and entity-specific attributes (e.g., legal structure, income, exemptions).

In one or more embodiments, the resulting comparison display may include computed tax liabilities, applicable rates, exemption eligibility, filing obligations, and available deductions or credits for each address. Differences may be highlighted visually, such as with color coding or icon indicators, to draw attention to advantageous or adverse outcomes. For example, the display might show that moving a business operation from Address A (in a first tax jurisdiction with a 2% income tax) across the street to Address B (in a second tax jurisdiction with a 1% rate and no LST) would reduce annual tax liability by a quantifiable amount. The interface may support additional functionality as follows: sorting comparisons by total tax burden, jurisdiction type, or tax category; toggling between different entity profiles or scenarios (e.g., employee vs. contractor); filtering to show only material differences or tax impacts above a certain threshold; and/or generating exportable reports or data outputs for audit, advisory, or filing purposes. The system may use ML models to suggest optimal configurations based on past comparisons or peer benchmarking data.

One or more embodiments receive input related to the tax implications/rules and/or recommendations related to the entity associated with the address (Operation 214). The system may include a feedback mechanism that allows users or integrated systems to submit input related to the tax implications, applicable rules, or generated recommendations associated with an entity at a specific address. This input may take various forms, including confirmations, corrections, selections, overrides, or freeform comments. The system may receive structured inputs, such as toggles indicating if a recommendation was accepted, values confirming exemption eligibility, or updates to entity attributes (e.g., residency status or income level) as well as unstructured feedback via text fields or annotation tools.

Upon receipt, the system may parse and validate the input to ensure the input is complete, relevant, and associated with a known entity-context pair. For structured inputs, the system may map the input to the specific tax implication or rule the input modifies or confirms, enabling downstream recalculation of tax outputs if required. For example, if a user provides input indicating that the entity qualifies for a local tax exemption not previously accounted for, the system flags the applicable rule as satisfied and triggers a recomputation of tax liability and reporting obligations.

In one or more embodiments, the system tracks which suggestions were accepted, dismissed, or deferred and optionally allows users to provide reasons or alternative decisions. The system may store this feedback as part of an audit log, influence future recommendation ranking (when ML is used), or be routed to administrative users for manual review. The system may receive inputs via API endpoints from external systems, such as payroll engines or tax filing platforms, allowing seamless integration and real-time synchronization of tax decisions across operational workflows.

One or more embodiments update the tax implication/rules and/or the entity data (Operation 216). The system may include functionality for updating tax implications, tax rules, and/or entity data in response to new input, changes in regulatory conditions, or updates from external systems. The update operation begins when a change is detected or received, such as a modification to the entity's attributes (e.g., address, income, legal structure, exemption eligibility), a user-provided override, or a change in jurisdictional boundaries or tax regulations. Upon detection, the system may identify the scope of the update and determine which components of the tax determination process are affected.

In one or more embodiments, when an update pertains to entity data, the system modifies the corresponding data record in the entity repository and flags any dependent tax determinations for recomputation. For example, a change in filing status or residency may affect exemption eligibility or tax rate applicability, prompting the system to retrieve and re-evaluate relevant tax rules. When an update pertains to tax rules or implications, such as a newly effective local tax rate or the expiration of a previously valid rule, the system may update the rule repository and trigger re-evaluation workflows for all affected addresses or entities. Rule metadata, such as jurisdictional applicability and effective date ranges, ensures that only relevant records are recalculated.

In one or more embodiments, during an update operation, the system maintains a version history of changes to preserve auditability and allow for retrospective analysis. The system may propagate any resulting changes in computed tax liabilities, due dates, filing requirements, and/or recommendations to downstream systems or present to users in updated interfaces. The update process may be automated through periodic syncing with regulatory databases, GIS sources, or integrated business systems, ensuring that tax outcomes remain accurate, current, and legally compliant as inputs evolve over time.

### 4. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

In an example, an employee is looking to relocate to an area in Westchester County, New York (NY). The employee has identified two houses directly across the street from one another. The employee is interested in determining the tax information for each of the houses before deciding on the house to purchase. The addresses for the two houses are as follows:
House 1 Address House 2 Address
3 Sprague Road 4 Sprague Road
Scarsdale, NY 10583 Scarsdale NY 10583

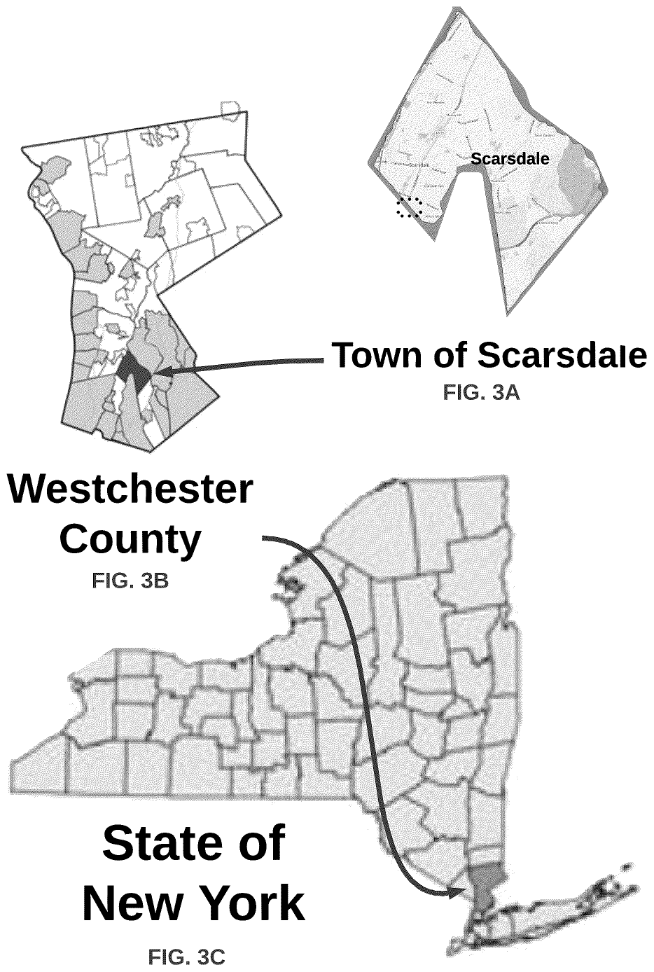

Because the two houses are on the same street and share ZIP code, 10583, traditional ZIP code or city name look-ups would treat the two addresses identically. By treating the addresses identically, traditional tax calculation systems risk mis-withholding or misallocation of revenue as well as incorrect filing instructions. Traditional systems would identify each of these addresses as being located in the Town of Scarsdale (FIG. 3A) in Westchester County (FIG. 3B) in the State of New York (FIG. 3C). Each of the town, county, and state may define separate taxing jurisdictions as defined by one or more polygons.

Similarly, traditional methods that rely on determining taxing jurisdictions based on a ZIP code also encounter shortcomings. FIG. 3D illustrates a geographic region comprising ZIP code 10583. As shown, the geographic region comprising ZIP code 10583 includes the entire Town of Scarsdale and all or portions of surrounding towns, including Greenburgh, Ardsley, Eastchester, New Rochelle, and Mamaroneck. Assuming that an address with a 10583 ZIP code falls within the Town of Scarsdale taxing jurisdiction and calculating tax information for an entity based on the Town of Scarsdale taxing jurisdiction would result in considerable different tax information for the employee than tax information calculated based on a taxing jurisdiction associated with an adjacent town.

FIG. 3E illustrates an enlarged view of an indicated area of detail in FIG. 3D. The enlarged view includes both the first and the second addresses of the houses the employee is interested in purchasing. The system determines the location of each address by determining a set of geographical coordinates, i.e., longitude and latitude, for each address. When each location is geocoded and the resulting coordinates are plotted against the system's polygon layer of local taxing jurisdictions, the point for the first address falls inside the polygon representing the Town of Scarsdale. The point for the second address does not fall inside the polygon representing the Town of Scarsdale. Instead, the point for the second address is captured by the immediately abutting polygon for the Town of Eastchester. This automated spatial distinction is critical to calculating the tax information for the employee looking to purchase a house.

The house located in the polygon representing the Town of Scarsdale is subject to Scarsdale's earned-income tax rate, school-district levy, and village service fees. The house located in the polygon representing the Town of Eastchester is subjected to Eastchester's lower earned-income rate and Eastchester's lower local-services tax. While both addresses share the same ZIP code and appear within the same municipality from a postal perspective, the addresses lie on opposite sides of a municipal boundary due to the irregular nature of jurisdictional delineations.

By converting each address into precise latitude and longitude coordinates and performing a point-in-polygon containment operation against stored GIS-defined jurisdiction boundaries, the system accurately identifies the taxing jurisdiction for each address. This fine-grained distinction enables the system to assign the correct tax rules, rates, and remittance obligations to the employee, avoiding misclassification and ensuring full legal compliance. Conventional systems relying on ZIP codes or municipality names would fail to capture this subtle yet critical difference, potentially resulting in erroneous tax assessments or filings. The address plotting and spatial resolution process disclosed herein materially improves the accuracy, reliability, and auditability of tax determination in geographically sensitive scenarios.

### 5. Practical Applications, Advantages, and Improvements

In one or more embodiments, a system that determines tax information for an entity based in part on plotting the entity's address into one of a set of polygons associated with taxing jurisdictions offers several practical applications, advantages, and improvements over existing solutions. The system enables precise, automated calculation of tax liabilities based on the specific geographic location of an entity, such as earned income tax, local services tax, or gross receipts tax, by accurately resolving the address to jurisdictional boundaries including cities, counties, school districts, and special tax zones. This supports real-time withholding for payroll systems, improves filing accuracy, and enables businesses to assess the tax impact of potential worksite or office locations. Additionally, the system facilitates government reporting and revenue attribution by ensuring tax obligations are allocated according to correct jurisdictional control.

The presently disclosed tax management system provides several advantages. The system replaces coarse, ZIP code-based approximations with high-precision spatial mapping using GIS polygon data, thereby increasing accuracy in areas with overlapping or irregular jurisdictions. The approach is scalable and dynamic, supporting large volumes of transactions and automatic updates to tax determinations as rules or boundaries evolve. By integrating tax rule evaluation directly with geographic resolution, the system ensures that jurisdiction-specific laws are applied contextually based on the entity's attributes, such as filing status, income, or residency, rather than through static lookup tables. The system supports versioned rule and boundary management, allowing historical, current, and future tax scenarios to be computed based on applicable law at any point in time.

Compared to traditional systems, this solution introduces many improvements. Manual or ZIP code-based systems are prone to jurisdictional errors, particularly where taxing boundaries split ZIP codes or follow custom delineations. The proposed system automates jurisdiction detection via point-in-polygon computations and overlays tax rule logic directly onto spatial data, eliminating human error and reducing compliance risk. Furthermore, by enabling rule-driven configuration and integration with other systems (e.g., enterprise resource planning, payroll, GIS), the system streamlines workflows and supports ML components that can offer predictive tax insights and cost-saving recommendations. Collectively, these innovations provide a scalable, intelligent, and jurisdictionally accurate tax determination framework that significantly outperforms legacy methods.

### 6. Machine Learning Architecture

FIG. 4 illustrates a machine learning engine 400 in accordance with one or more embodiments. As illustrated in FIG. 4, machine learning engine 400 includes input/output module 420, data preprocessing module 422, model selection module 424, training module 426, evaluation and tuning module 428, and inference module 430.

In accordance with an embodiment, input/output module 420 serves as the primary interface for data entering and exiting the system, managing the flow and integrity of data. This module may accommodate a wide range of data sources and formats to facilitate integration and communication within the machine learning architecture.

In an embodiment, an input handler within input/output module 420 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 420 to be versatile in different operational contexts, whether processing historical datasets or streaming data.

In accordance with an embodiment, input/output module 420 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 420 includes an output framework designed to handle the distribution and exportation of outputs, predictions, or insights. Using the output framework, input/output module 420 formats these outputs into user-friendly and accessible formats, such as reports, visualizations, or data files compatible with other systems. Input/output module 420 also ensures secure and efficient transmission of these outputs to end-users or other systems in an embodiment and may employ encryption and secure data transfer protocols to maintain data confidentiality.

In accordance with an embodiment, data preprocessing module 422 transforms data into a format suitable for use by other modules in machine learning engine 400. For example, data preprocessing module 422 may transform raw data into a normalized or standardized format suitable for training ML models and for processing new data inputs for inference. In an embodiment, data preprocessing module 422 acts as a bridge between the raw data sources and the analytical capabilities of machine learning engine 400.

In an embodiment, data preprocessing module 422 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 422 may be configured to handle anomalies in different ways depending on context. Data preprocessing module 422 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 422 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 422 processes new data for inference, data preprocessing module 422 replicates the same preprocessing steps to ensure consistency with the training data format. This helps to avoid discrepancies between the training data format and the inference data format, thereby reducing the likelihood of inaccurate or invalid model predictions.

In an embodiment, model selection module 424 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 424 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 424 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 424 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 424 also considers computational efficiency and resource constraints. This is meant to help ensure the selected model is both accurate and practical in terms of computational and time requirements. In an embodiment, certain features of model selection module 424 are configurable such as a configured bias toward (or against) computational efficiency.

In accordance with an embodiment, training module 426 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 426 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 426 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 426 includes logic to handle different types of data and learning tasks. For instance, it includes different training routines for supervised learning (where the training data comes with labels) and unsupervised learning (without labeled data). In the case of deep learning models, training module 426 also manages the complexities of training neural networks that include initializing network weights, choosing activation functions, and setting up neural network layers.

In an embodiment, evaluation and tuning module 428 incorporates dynamic feedback mechanisms and facilitates continuous model evolution to help ensure the system's relevance and accuracy as the data landscape changes. Evaluation and tuning module 428 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 428 performs continuous model tuning by using hyperparameter optimization. Evaluation and tuning module 428 performs an exploration of the hyperparameter space using algorithms, such as grid search, random search, or more sophisticated methods like Bayesian optimization. Evaluation and tuning module 428 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 428 integrates data feedback and updates the model. Evaluation and tuning module 428 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 428 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 428 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 430 transforms data raw data into actionable, precise, and contextually relevant predictions. In addition to processing and applying a trained model to new data, inference module 430 may also include post-processing logic that refines the raw outputs of the model into meaningful insights.

In an embodiment, inference module 430 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 430 transforms the outputs of a trained model into definitive classifications. Inference module 430 employs the underlying model as a tool to generate probabilistic outputs for each potential class. It then engages in an interpretative process to convert these probabilities into concrete class labels.

In an embodiment, when inference module 430 receives the probabilistic outputs from the model, it analyzes these probabilities to determine how they are distributed across some or every potential class. If the highest probability is not significantly greater than the others, inference module 430 may determine that there is ambiguity or interpret this as a lack of confidence displayed by the model.

In an embodiment, inference module 430 uses thresholding techniques for applications where making a definitive decision based on the highest probability might not suffice due to the critical nature of the decision. In such cases, inference module 430 assesses if the highest probability surpasses a certain confidence threshold that is predetermined based on the specific requirements of the application. If the probabilities do not meet this threshold, inference module 430 may flag the result as uncertain or defer the decision to a human expert. Inference module 430 dynamically adjusts the decision thresholds based on the sensitivity and specificity requirements of the application, subject to calibration for balancing the trade-offs between false positives and false negatives.

In accordance with an embodiment, inference module 430 contextualizes the probability distribution against the backdrop of the specific application. This involves a comparative analysis, especially in instances where multiple classes have similar probability scores, to deduce the most plausible classification. In an embodiment, inference module 430 may incorporate additional decision-making rules or contextual information to guide this analysis, ensuring that the classification aligns with the practical and contextual nuances of the application.

In regression models, where the outputs are continuous values, inference module 430 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 430 incorporates domain-specific adjustments into its post-processing routine. This involves tailoring the model's output to align with specific industry knowledge or contextual information. For example, in financial forecasting, inference module 430 may adjust predictions based on current market trends, economic indicators, or recent significant events, ensuring that the outputs are both statistically accurate and practically relevant.

In an embodiment, inference module 430 includes logic to handle uncertainty and ambiguity in the model's predictions. In cases where inference module 430 outputs a measure of uncertainty, such as in Bayesian inference models, inference module 430 interprets these uncertainty measures by converting probabilistic distributions or confidence intervals into a format that can be easily understood and acted upon. This provides users with both a prediction and an insight into the confidence level of that prediction. In an embodiment, inference module 430 includes mechanisms for involving human oversight or integrating the instance into a feedback loop for subsequent analysis and model refinement.

In an embodiment, inference module 430 formats the final predictions for end-user consumption. Predictions are converted into visualizations, user-friendly reports, or interactive interfaces. In some systems, like recommendation engines, inference module 430 also integrates feedback mechanisms, where user responses to the predictions are used to continually refine and improve the model, creating a dynamic, self-improving system.

FIG. 5 illustrates the operation of a machine learning engine in one or more embodiments. In an embodiment, input/output module 420 receives a dataset intended for training (Operation 501). This data can originate from diverse sources, like databases or real-time data streams, and in varied formats, such as CSV, JSON, or XML. Input/output module 420 assesses and validates the data, ensuring its integrity by checking for consistency, data ranges, and types.

In an embodiment, training data is passed to data preprocessing module 422. Here, the data undergoes a series of transformations to standardize and clean it, making it suitable for training ML models (Operation 502). This involves normalizing numerical data, encoding categorical variables, and handling missing values through techniques like imputation.

In an embodiment, prepared data from the data preprocessing module 422 is then fed into model selection module 424 (Operation 503). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 426 trains the selected model with the prepared dataset (Operation 504). It implements learning algorithms to adjust the model's internal parameters, optimizing them to identify patterns and relationships in the training data. Training module 426 also addresses the challenge of overfitting by implementing techniques, like regularization and early stopping, ensuring the model's generalizability.

In an embodiment, evaluation and tuning module 428 evaluates the trained model's performance using the validation dataset (Operation 505). Evaluation and tuning module 428 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 420 receives a dataset intended for inference. Input/output module 420 assesses and validates the data (Operation 506).

In an embodiment, data preprocessing module 422 receives the validated dataset intended for inference (Operation 507). Data preprocessing module 422 ensures that the data format used in training is replicated for the new inference data, maintaining consistency and accuracy for the model's predictions.

In an embodiment, inference module 430 processes the new data set intended for inference, using the trained and tuned model (Operation 508). It applies the model to this data, generating raw probabilistic outputs for predictions. Inference module 430 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 440 allows for applications to leverage machine learning engine 400. In an embodiment, machine learning engine API 440 may be built on a RESTful architecture and offer stateless interactions over standard HTTP/HTTPS protocols. Machine learning engine API 440 may feature a variety of endpoints, each tailored to a specific function within machine learning engine 400. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 440 is equipped to support SOAP-based interactions. This extension involves defining a WSDL (Web Services Description Language) document that outlines the API's operations and the structure of request and response messages. In an embodiment, machine learning engine API 440 supports various data formats and communication styles. In an embodiment, machine learning engine API 440 endpoints may handle requests in JSON format or any other suitable format. For example, machine learning engine API 440 may process XML, and it may also be engineered to handle more compact and efficient data formats, such as Protocol Buffers or Avro, for use in bandwidth-limited scenarios.

In an embodiment, machine learning engine API 440 is designed to integrate WebSocket technology for applications necessitating real-time data processing and immediate feedback. This integration enables a continuous, bi-directional communication channel for a dynamic and interactive data exchange between the application and machine learning engine 400.

### 7. Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 420, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 422 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 424, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 426, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 428 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 430, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

The self-attention mechanism, which is part of a transformer network, enables the model to weigh the importance of different elements within an input sequence, regardless of their position. This allows the model to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

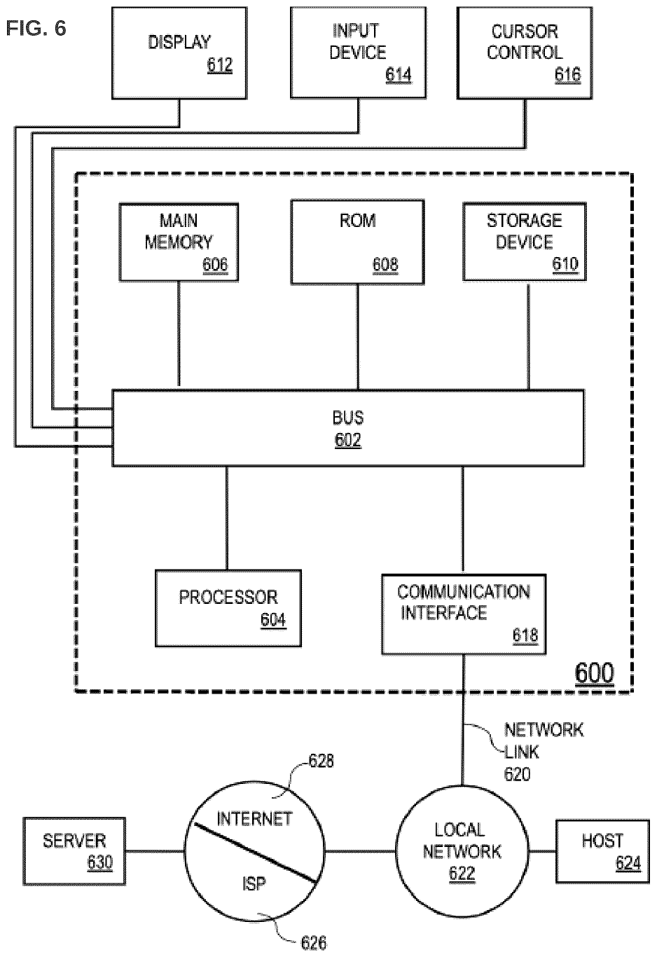

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
receiving one or more geospatial files for a geographical region;
partitioning the geographical region into a plurality of polygons based on the one or more geospatial files, each of the plurality of polygons being associated with one or more of a plurality of taxing jurisdictions; and
receiving an entity data associated with an entity, the entity data comprising a first address for the entity and one or more tax attributes for the entity;
determining a first set of geographical coordinates of the first address within the geographical region;
plotting the first address in the geographical region based on the first set of geographical coordinates of the first address;
determining at least one polygon of the plurality of polygons that includes the first address plotted within the geographical region;
determining at least one taxing jurisdiction corresponding to the at least one polygon;
based on the at least one taxing jurisdiction and the one or more tax attributes of the entity, determining a first set of tax information for the entity; and
presenting the first set of tax information for the entity, wherein the method is performed by at least one device including a hardware processor.

2. The method of claim 1, further comprising:
determining a respective portion of the geographical region associated with each of the plurality of taxing jurisdictions; and
determining the plurality of polygons based on the plurality of taxing jurisdictions.

3. The method of claim 1, wherein two or more polygons of the plurality of polygons at least partially overlap;
wherein a first polygon of the two or more polygons is associated with a first region type from a group of region types including a town, city, county, state or country;
wherein a second polygon of the two or more polygons is associated with a second region type from the group of region types, the first region type being different from the second region type;
wherein the first address is determined to be plotted in a first polygon corresponding to the first region type and a second polygon corresponding to the second region type;
wherein the first set of tax information for the entity includes a first subset of tax information associated with the first region type based in part on the first polygon and a second subset of tax information associated with the second region type based in part on the second polygon.

4. The method of claim 1, wherein a first polygon and a second polygon of the plurality of polygons respectively comprise (a) a first set of addresses on a first side of a street and (b) a second set of addresses on a second side of the street, and
wherein based on first address being on the first side of the street, the first address is included in the first polygon and not included in the second polygon.

5. The method of claim 1, further comprising:
determining that the first address is associated with an entity on a particular day; and
determining the plurality of polygons, associated with the plurality of taxing jurisdictions, based in part on the particular day.

6. The method of claim 1, further comprising:
determining that the first address is associated with an entity during a particular time period;
wherein the first set of tax information for the entity is determined based further in part on the particular time period.

7. The method of claim 1, wherein the first set of tax information for the entity comprises tax liabilities for the entity.

8. The method of claim 1, further comprising:
receiving an update to the entity data, the update comprising a second address for the entity;
determining a second set of geographical coordinates of the second address within the geographical region;
plotting the second address in the geographical region based on the second set of geographical coordinates of the second address;
determining a second polygon of the plurality of polygons that includes the second address plotted within the geographical region;
determining a second taxing jurisdiction corresponding to the second polygon;
based on the second taxing jurisdiction and the one or more tax attributes of the entity, determining a second set of tax information for the entity; and
presenting the second set of tax information for the entity concurrently with presenting the first set of tax information for the entity.

9. The method of claim 1, wherein the first address corresponds to the entity for a first period of time, wherein the entity data further comprises a second address that is associated with the entity for a second period of time, and further comprising:
determining a second set of geographical coordinates of the second address within the geographical region;
plotting the second address in the geographical region based on the second set of geographical coordinates of the second address;
determining a second polygon of the plurality of polygons that includes the second address plotted within the geographical region;
determining a second taxing jurisdiction corresponding to the second polygon;
based on the second taxing jurisdiction and the one or more tax attributes of the entity, wherein the first set of tax information for the entity is based further on the second taxing jurisdiction.

10. One or more non-transitory computer readable media comprising instructions which, when executed by one or more hardware processors, cause performance of operations comprising:
receiving one or more geospatial files for a geographical region;
partitioning the geographical region into a plurality of polygons based on the one or more geospatial files, each of the plurality of polygons being associated with one or more of a plurality of taxing jurisdictions; and
receiving an entity data associated with an entity, the entity data comprising a first address for the entity and one or more tax attributes for the entity;
determining a first set of geographical coordinates of the first address within the geographical region;
plotting the first address in the geographical region based on the first set of geographical coordinates of the first address;
determining at least one polygon of the plurality of polygons that includes the first address plotted within the geographical region;
determining at least one taxing jurisdiction corresponding to the at least one polygon;
based on the at least one taxing jurisdiction and the one or more tax attributes of the entity, determining a first set of tax information for the entity; and
presenting the first set of tax information for the entity.

11. The one or more non-transitory computer readable media of claim 10, wherein the operations further comprise:
determining a respective portion of the geographical region associated with each of the plurality of taxing jurisdictions; and
determining the plurality of polygons based on the plurality of taxing jurisdictions.

12. The one or more non-transitory computer readable media of claim 10, wherein two or more polygons of the plurality of polygons at least partially overlap;
wherein a first polygon of the two or more polygons is associated with a first region type from a group of region types including a town, city, county, state or country;
wherein a second polygon of the two or more polygons is associated with a second region type from the group of region types, the first region type being different from the second region type;
wherein the first address is determined to be plotted in a first polygon corresponding to the first region type and a second polygon corresponding to the second region type;
wherein the first set of tax information for the entity includes a first subset of tax information associated with the first region type based in part on the first polygon and a second subset of tax information associated with the second region type based in part on the second polygon.

13. The one or more non-transitory computer readable media of claim 10, wherein a first polygon and a second polygon of the plurality of polygons respectively comprise (a) a first set of addresses on a first side of a street and (b) a second set of addresses on a second side of the street, and
wherein based on first address being on the first side of the street, the first address is included in the first polygon and not included in the second polygon.

14. The one or more non-transitory computer readable media of claim 10, wherein the operations further comprise:
determining that the first address is associated with an entity on a particular day; and
determining the plurality of polygons, associated with the plurality of taxing jurisdictions, based in part on the particular day.

15. The one or more non-transitory computer readable media of claim 10, wherein the operations further comprise:
determining that the first address is associated with an entity during a particular time period;
wherein the first set of tax information for the entity is determined based further in part on the particular time period.

16. The one or more non-transitory computer readable media of claim 10, wherein the first set of tax information for the entity comprises tax liabilities for the entity.

17. The one or more non-transitory computer readable media of claim 10, wherein the operations further comprise:
receiving an update to the entity data, the update comprising a second address for the entity;
determining a second set of geographical coordinates of the second address within the geographical region;
plotting the second address in the geographical region based on the second set of geographical coordinates of the second address;
determining a second polygon of the plurality of polygons that includes the second address plotted within the geographical region;
determining a second taxing jurisdiction corresponding to the second polygon;
based on the second taxing jurisdiction and the one or more tax attributes of the entity, determining a second set of tax information for the entity; and
presenting the second set of tax information for the entity concurrently with presenting the first set of tax information for the entity.

18. The one or more non-transitory computer readable media of claim 10, wherein the first address corresponds to the entity for a first period of time, wherein the entity data further comprises a second address that is associated with the entity for a second period of time, and wherein the operations further comprise:
determining a second set of geographical coordinates of the second address within the geographical region;
plotting the second address in the geographical region based on the second set of geographical coordinates of the second address;
determining a second polygon of the plurality of polygons that includes the second address plotted within the geographical region;
determining a second taxing jurisdiction corresponding to the second polygon;
based on the second taxing jurisdiction and the one or more tax attributes of the entity, wherein the first set of tax information for the entity is based further on the second taxing jurisdiction.

19. A system comprising:
one or more hardware processors;
one or more non-transitory computer-readable media; and
program instructions stored on the one or more non-transitory computer-readable media which, when executed by the one or more hardware processors, cause the system to:
receiving one or more geospatial files for a geographical region;
partition the geographical region into a plurality of polygons based on the one or more geospatial files, each of the plurality of polygons being associated with one or more of a plurality of taxing jurisdictions; and
receive an entity data associated with an entity, the entity data comprising a first address for the entity and one or more tax attributes for the entity;
determine a first set of geographical coordinates of the first address within the geographical region;
plot the first address in the geographical region based on the first set of geographical coordinates of the first address;
determine at least one polygon of the plurality of polygons that includes the first address plotted within the geographical region;
determine at least one taxing jurisdiction corresponding to the at least one polygon;
based on the at least one taxing jurisdiction and the one or more tax attributes of the entity, determine a first set of tax information for the entity; and
present the first set of tax information for the entity.

20. The system of claim 19, wherein the program instructions further cause the system to:
determine a respective portion of the geographical region associated with each of the plurality of taxing jurisdictions; and
determine the plurality of polygons based on the plurality of taxing jurisdictions.
